(19) United States
(12) Patent Application Publication
(10) Pub. No.: US 2010/0209148 A1
(43) Pub. Date: Aug. 19, 2010

(54) IMAGE FORMING METHOD EMPLOYING CLEAR TONER

(75) Inventors: Ryuichi HIRAMOTO, Tokyo (JP); Shigenori KOUNO, Tokyo (JP); Takao YAMANOUCHI, Kanagawa (JP); Kazue NAKAMURA, Tokyo (JP); Michiyo FUJITA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/701,647

(22) Filed: Feb. 8, 2010

(30) Foreign Application Priority Data
Feb. 13, 2009 (JP) 2009031053

(51) Int. Cl. G03G 15/16

(52) U.S. Cl. 399/297

(57) ABSTRACT

A method of image forming comprising the steps of: providing a clear toner all over a transfer material on which an image is formed; heating and pressing the transfer material having thereon the image while the transfer material is in contact with a belt; cooling the transfer material; and peeling the transfer material from the belt, whereby a clear toner layer formed on the transfer material is obtained, wherein a storage modulus G′ at 60° C. of the clear toner is 1×10⁶ N/m² or more, but 1×10⁶ N/m² or less; and a viscosity η at 130° C. of the clear toner is 1×10¹ Pa·s or more, but 1×10² Pa·s or less.

### FIELD OF THE INVENTION

The present invention relates to a transparent and colorless toner which is called as a clear toner used in order to give gloss to an image surface formed by a well-known picture formation equipment, such as an electrophotographic printer or an ink-jet printer.

### BACKGROUND OF THE INVENTION

Printed images represented by a photograph picture and a poster have recently been formed by an inkjet printer or an electrophotographic image forming apparatus, in addition to conventional printing systems, such as a silver-salt photo system and a gravure printing system.

For example, in the field of an image forming technology of an electrophotographic system, such as a copier or a printer, reproduction of a minute dot picture of a 1200 dpi level (dpi representing a number of dots per inch (2.54 cm)) has become possible according to the progress of technology, such as digitization of an exposure system and reduction of the diameter of toner particles. Further, a technology which enables formation of a full-color image has been developed, in which a toner image is formed on each of a plurality of photoreceptor drums, the formed toner images are superimposed by primarily transferring the toner images on an intermediate transfer member, and the toner image transferred on the intermediate transfer member is secondarily transferred on a transfer material. Thus, due to the improvement in the image forming technology, full color images for which a high resolution like a photographic picture is required have become possible to be formed by employing such technologies, in addition to the conventional silver-salt photo technology and printing technology.

A glossy image is often desired for a photograph picture such as a poster. However, when an image is formed employing a toner, while the domain of a toner image fixed on a transfer material, for example, a paper, has a certain extent of gloss, a white part tends to have a glossless finish. Since such an unbalanced gloss would reduce the quality of the imprint image, the countermeasure has been demanded.

From such a background, a technology of image formation employing a toner having a composition in which a colorant component is removed from the composition of an ordinary colored toner, which is called as a clear toner or a transparent toner, has come to be examined, as a technology to reduce the unevenness in the gloss of an image. Specifically, a technology to form an image print exhibiting a uniform gloss all over the print by forming a clear toner layer on all over the image by supplying a clear toner all over the transfer material on which an image is formed, followed by heating and cooling, has been proposed (for example, refer to Patented Documents 1). Also, a device which provides a glossy print by forming a transparent toner layer on the surface of the printed image formed, for example, by a printer, which is called as a gloss-providing device, has appeared. This device is connected to, for example, an electrophotographic printer. After forming a transparent toner layer all over the image produced by the printer, the image is heated while the transparent toner layer is in contact with a belt member. Then, the transparent toner layer is cooled in the state where the transparent toner layer is in contact with the belt member to harden the transparent toner layer, followed by peeling the print from the belt member, whereby an image having uniform gloss is provided (for example, refer to Patent Documents 2 and 3). Further, a technology to form a full color image having a gloss without unevenness is being examined by focusing attention on the difference in the properties of the toner forming the image and the transparent toner provided all over the image, for example, the difference in the diameters of the color toner and the transparent toner (for example, refer to Patent Document 4).

Thus, the technology to uniformize the gloss of the image by providing a transparent toner layer on all over the image has been examined. However, it was found, in the present invention, that it is rather difficult for the conventional technologies more than has been supposed so far to stably produce a print having a uniform gloss without unevenness. Namely, when a large number of prints were formed according to the technology disclosed, for example, in aforementioned Patent document 2, glossy print sheets without unevenness were obtained until around 100,000 sheets, however, when the total number of print sheet exceeds 150,000, unevenness tends to occur on the print sheet. It was confirmed that large number of fine cracks were formed on the surface of a belt member when the total number of print sheet exceeds 150,000, which was supposed to be caused by the deterioration of the belt surface which contacted with the clear toner layer due to the repeated heating and cooling.

As described above, replacement of a belt member has been needed when the total number of print sheet exceeds 150,000. Accordingly, commercial printers mainly dealing with on demand printing have had to frequently replace the belt member, which has not been favorable in view of the maintenance of the device. The order number of sheet accepted by the commercial printer is sometimes in the level of several thousands of sheets. Therefore, the necessity of replacement of the belt member on every 150,000 sheets would affect a smooth pursuance of the printing service as well as increasing the running cost of the printing device.

In view of the foregoing problems, a development of a clear toner which enables a higher cooling temperature of the clear toner layer to reduce the thermal load to the belt member was conducted. As the result, only by increasing the cooling temperature while the melting temperature was unchanged, the thermal load to the belt member was reduced, however, no glossy image was obtained. This would be because the adhesion of the clear toner layer to the belt member became too high and a part of the clear toner layer remained on the belt member when the clear toner layer was exfoliated from the belt member, whereby the flatness of the clear toner layer was lost. Thus, the approach to obtain an image print having uniform gloss by focusing attention on the temperature property of the clear tone was not successful.

Patent document 1 Japanese Patent Application Publication Open to Public Inspection (hereafter referred to as JP-A) No. 11-7174

Patent document 2 JP-A No. 2002-341619

Patent document 3 JP-A No. 2004-258537

Patent document 4 JP-A No. 2007-140037

### SUMMARY OF THE INVENTION

An object of the present invention is to provide a method of forming an image having a uniform gloss by providing a clear toner layer on all over a transfer material, followed by heating and then cooling. Namely, an object of the present invention is to overcome the problem regarding the clear toner used for a method of forming a image to form an image having a glossy surface by heating and the cooling an image print on which a clear toner layer is provided on all over the print while the print is supported on a belt member.

More specifically, an object of the present invention is to provide a method of forming an image employing a clear toner which enables providing an image having a uniform gloss without deteriorating a belt member even after the total number of print sheet exceeded 200,000 sheets. Namely, the clear toner was designed, in which the difference between the heating temperature and the following cooling temperature was decreased by lowering the heat applied to the belt member when the clear toner is heated to melt, whereby the deterioration of the belt member was suppressed. In other words, the thermal load applied to the belt member was reduced by decreasing the difference between the heating temperature to melt the clear toner layer and the cooling temperature to cool the clear toner layer.

The above object of the present invention is achieved by the following structures:

(1) A method of image forming comprising the steps of:

providing a clear toner all over a transfer material on which an image is formed;

heating and pressing the transfer material having thereon the image while the transfer material is in contact with a belt;

cooling the transfer material; and

peeling the transfer material from the belt, whereby a clear toner layer formed on the transfer material is obtained, wherein

a storage modulus G′ at 60° C. of the clear toner is 1×10⁶ N/m² or more, but 1×10⁸ N/m² or less; and

a viscosity η at 130° C. of the clear toner is 1×10¹ Pa·s or more, but 1×10² Pa·s or less.

(2) The method of Item (1), wherein the clear toner comprises a resin prepared by using a polycarboxylic acid monomer.
(3) The method of Item (2), wherein the polycarboxylic acid monomer comprises itaconic acid, maleic acid or a mixture thereof.
(4) The method of Item (3), wherein the polycarboxylic acid monomer is itaconic acid.
(5) The method of Item (3), wherein the polycarboxylic acid monomer is maleic acid.
(6) The method of any one of Items (2)-(5), wherein a used amount of the polycarboxylic acid monomer is 3 to 15% by mass based on a total mass of the clear toner.
(7) The method of any one of Items (2)-(6), wherein a used amount of the polycarboxylic acid monomer is 5 to 10% by mass based on a total mass of the clear toner.
(8) The method of any one of Items (1)-(7), wherein the clear toner has a core-shell structure.

### BRIEF DESCRIPTION OF THE DRAWINGS

FIG. 1 is a schematic diagram of a gloss-providing device which can form a glossy surface all over the image formed on a transfer material employing a clear toner.

FIG. 2 is a cross-sectional configuration diagram of an image forming device which forms a full color toner image and also a clear toner layer all over the full color toner image.

FIG. 3 is a schematic diagram showing an example of a device in which a gloss-providing device is installed in the image forming device of FIG. 2.

FIG. 4 is a schematic diagram showing an example of a device in which a gloss-providing device is installed in the image forming device of FIG. 2.

FIG. 5 is a conceptual diagrams of a glossiness measuring devices (gross meter).

### DESCRIPTION OF THE PREFERRED EMBODIMENTS

According to the present invention, provided is a method of forming an image employing a clear toner which enables forming an image having a uniform gloss by forming a clear toner layer on all over a transfer material, followed by heating and then cooling the transfer material while the transfer material is in contact with a belt member. Namely, by forming an image print employing a clear toner according to the present invention, the heat necessary to heat and melt the clear toner layer can be reduced, whereby the temperature difference with the temperature at the following cooling step can also be reduced. As the result, the deterioration of the belt member can be avoided and the factors to deteriorate a glossy surface due to the unevenness caused by the cracks or a wrinkle formed on the belt member can be prevented, even after the clear toner layer formation is repeated more than 200,000 sheets.

The clear tone employed in the present invention exhibits a storage modulus G′ at 60° C. of 1×10⁶ N/m² or more, but 1×10⁸ N/m² or less, and a viscosity η at 130° C. of 1×10¹ Pa·s or more, but 1×10² Pa·s or less. In the present invention, in order to overcome the abovementioned problem, the attention was focused on the viscoelasticity of the clear toner, and it was found that, when the viscosity at 130° C. of the clear toner is in the above range, the clear toner layer can be fully melted at a heating temperature lower than the conventional heating temperature. Namely, when a clear toner having a viscosity in the abovementioned range is used, an excellent meltability of the clear toner can be achieved at a lower heating temperature, and the life of the belt member can be prolonged because the thermal load applied to the belt member which conveys the print while being in contact with the print can also be reduced.

A clear toner layer formed with a clear toner exhibiting an excellent meltability at a lower heating temperature has had a problem in the impact resistance after hardened by cooling. Namely, it has been difficult for a conventional clear toner to obtain a clear toner layer surface exhibiting uniform glossiness because the clear toner layer hardened by cooling tends to be deformed or fracture by an external force due to, for example, conveyance.

It was found in the present invention that, when the storage-modulus G′ at 60° C. of a clear toner is in the abovementioned range, no deformation nor fracture occurs easily even when a certain extent of impact is applied to the clear toner layer hardened by cooling, whereby the surface condition is maintained to exhibit a uniform glossiness.

Thus, the inventors of the present invention focused on the viscosity η as an index of the meltability by which the clear toner layer can be melted at a temperature lower than the conventional heating temperature, as well as on the storage modulus G′ as an index of the impact resistance by which no deformation nor fracture occurs easily even when a certain extent of impact is applied to the clear toner layer hardened by cooling. The load applied to the belt member due to the thermal load could be reduced by realizing an environment where the temperature change is smaller, by prescribing these two viscoelastic parameters.

Hereafter, the present invention will be explained in detail. The “clear toner” as used in the present invention is a toner particle which does not contain a colorant (for example, coloration pigments, a coloration dye, black carbon particles, black magnetic particles) which exhibits coloration by absorption of light or dispersion of light. The clear toner used in the present invention is colorless and transparent. Although, in some cases, the transparency becomes slightly lower depending on the kind and the amount of added binder resin, wax or external additive, the clear toner is substantially colorless and transparent.

The “image” as used in the present invention means a medium which provides information to a user, for example, a character image or a picture image (or an illustration image). Namely, the image means not only the region where a toner, ink, etc. exist on a transfer material, but also the region including the white background where neither toner nor ink exists, and has a form which can provide information to a user. The “image” as used in the present invention includes both an image having a clear toner layer and an image having no clear toner layer. Further, in the present invention, the method of forming the image before providing a clear toner layer is not specifically limited, and the target of the present invention includes images formed by the well-known image formation methods, such as an electrophotographic method, a printing method, an inkjet printing method, and a silver-salt photographic method.

Next, the viscosity η and the storage modulus G′ both of which prescribe the viscoelasticity of the clear toner according to the present invention will be explained, respectively.

First, the viscosity η of the clear toner according to the present invention will be explained. The clear toner according to the present invention has a viscosity η at 130° C. of 1×10′ Pa·s or more, but 1×10² Pa·s or less. In the present invention, when a clear toner having a viscosity η meeting the abovementioned range is used, the quantity of heat required for heating and melting can be reduced, since the clear toner layer is fully melted at a heating temperature lower than the conventional heating temperature. Consequently, the thermal load applied to the member which holds and conveys the image print carrying a clear toner layer within equipment is reduced, whereby the life of these members constituting the device can be prolonged. Recently, on-demand printers who receives a print production request of the level of thousands of sheet at one time has also appeared. Since the parts replacements frequency decreases, it is effective to improve the print making efficiency.

In the present invention, by using a clear toner having a viscosity η at 130° C. of 1×10¹ Pa·s or more, but 1×10² Pa·s or less, the clear toner layer can be fully melted at a heating temperature lower than the conventional heating temperature. When a clear toner having a viscosity η at 130° C. larger than 1×10² Pa·s is used, only insufficient meltability is obtained. Accordingly, reduction of thermal burden on the members constituting the device cannot be expected. Further, since no sufficient flatness can be obtained on the surface of the image on which a clear toner is melted due to the low fluidity, an image having uniform glossiness is hardly obtained.

On the other hand, when a clear toner having a viscosity η at 130° C. smaller than 1×10² Pa·s is used, a sufficient meltability of the clear toner can be obtained even when the heating temperature is further lowered, by which adhesion of the clear toner layer can be raised. However, the adhesion of the clear toner layer with the belt member may become too strong, and, a part of the clear toner layer may remain on the belt member surface when the clear toner layer is exfoliated from the belt member after cooling. As a result, the flatness of the clear toner layer surface may be lowered, and an image with high gloss is difficult to obtain.

A problem of lowered gloss on the image due to hot offset may occur, namely, since a clear toner tends to adheres to the belt member and becomes easy to remain on the belt, the clear toner which adhered and remained on the belt may further transfer to the next image to cause unevenness in the gloss of the next image. Further, when such hot offset occurs, there exit portions where the cleat toner is exfoliated, whereby no surface having uniform gloss is formed, which affects the durability and the quality of the image.

In the measurement of the viscosity η of the clear toner according to the present invention, a viscosity measuring device is employed. More specifically, a soliquid meter MR-500 produced by RHEOLOGY Co., Ltd., which will be described in detail later for the determination of a storage modulus, may be used.

Next, the storage-modulus G′ of the clear toner will be explained. As abovementioned, the clear toner according to the present invention has a storage modulus G′ at 60° C. of 1×10⁶ N/m² or more, but 1×10⁸ N/m² or less. In the present invention, by employing a clear toner having a storage modulus at 60° C. meeting the abovementioned range, an image print can be collected from the image forming devices without giving load and impact to the clear toner layer on which an excellent flatness is provided by being cooled while being held on a flat surface of the belt member. Therefore, since the flatness of the clear toner layer surface is maintained, a uniform gloss without unevenness of the collected image can be stably obtained.

Thus, in the present invention, an image print exhibiting a uniform gloss without unevenness can be stably prepared by focusing on the viscoelasticity of the clear toner and by employing a clear tone having a storage modulus at a prescribed temperature and a viscosity at a prescribed temperature each within its prescribed range of value.

The storage modulus will be further explained. The storage modulus of the clear toner according to the present invention is based on the concept about the dynamic viscoelasticity of the clear toner, as described below. A dynamic viscoelasticity means a viscoelasticity obtained by applying a distortion or a stress which varies with time like a sinusoidal vibration to a sample and measuring the corresponding distortion or stress to evaluate the viscoelesticity of the sample. Thus, the viscoelasticity acquired through sinusoidal vibration is called a “dynamic viscoelasticity”. The elastic modulus obtained through a sinusoidal vibration is usually represented by the form of a complex number.

The elastic modulus G is a fraction of applied stress σ divided by distortion γ caused by the stress σ, and the elastic modulus as a dynamic elastic modulus is called as a complex elastic modulus G*. Namely, a complex elastic modulus G* as a dynamic elastic modulus is represented as follows, provided that the stress is represented by σ* and the distortion is represented by γ*.

G*=σ*/γ*

The real part of the complex elastic modulus G* is called as a “storage modulus”, and the imaginary part is called as a “loss elastic modulus”. The concept of the storage modulus used as the factor which specifies the clear toner according to the present invention will be explained.

When a sinusoidal distortion γ having an amplitude γ₀ and a radian frequency ω is applied to a sample, the sinusoidal distortion γ is represented as follows.

γ=γ₀ cos ωτ

In this state, a stress of the same radian frequency is generated in the sample. The stress σ has a phase faster than the distortion γ by δ. Therefore the stress σ can be expressed as follows.

σ=σ₀ cos (ωt+δ)

Here, if these formulas are expressed by a complex number using the Euler's rule e^{iωt} cos ωt+isin ωt, the sinusoidal distortion γ* is γ*=γ₀ exp(iωt). The stress σ* caused by the distortion is expressed as σ*=σ₀ exp(i(ωt+δ)).

When substituting the above equation into the abovementioned complex elastic modulus G*=σ*/γ*:

$${G}^{*} = ( {σ}_{0} / {γ}_{0} ) exp i δ \\ = ( {σ}_{0} / {γ}_{0} ) ( cos δ + i sin δ ) .$$

When the complex elastic modulus G* is represented with the real part and the imaginary part, namely, G*=G′+iG″):

G′=(σ₀/γ₀) cos δ

G″=(σ₀/γ₀) sin δ

These equations means that the elastic energy stored in one cycle is proportional to G′ and the energy lost as heat by the elastic material is proportional to G″. Accordingly, the real part G′ is called as a storage modulus and the imaginary part G″ is called as a loss elastic modulus.

The storage modulus G′ of the clear toner according to the present invention can be calculated, for example, by measuring in the procedure shown below.

(1) Forming 0.5 g of a clear toner into a pellet of 1 cm in diameter employing a compression molding machine by applying a weight of 3 tons for 30 seconds.
(2) Loading the pellet between parallel plates with a diameter of 1 cm.
(3) Setting the measurement temperature at 120° C. and the gap between the parallel plates at 3 mm, whereby the measurement section is heated first to 120° C. and the sample is pressed until the gap decreased to 3 mm, followed by cooling to −20° C. using liquid nitrogen.
(4) Setting the temperature of the measurement section at −20° C. using liquid nitrogen, raising the temperature of the measurement section up to 200° C. in a rate of 5° C./minute while applying a sinusoidal vibration of 1.0 Hz, and measuring the complex elastic modulus at each prescribed temperature, where the distortion angle is automatically controlled, and the automatic distortion angle control is carried out by checking the measuring condition in every 2-4 cycles after start reading the data, whereby the distortion angle is controlled by the torque peak at the instance, the torque peak being obtained by averaging the values of the torque wave from 0 to the peak.

When the above procedures are summarized, the storage modulus G′ and the viscosity η of the clear toner according to the present invention will be obtained by measuring under the following conditions:
Measuring device: soliquid meter MR-500 produced by RHEOLOGY Co., Ltd.
Frequency: 1.0 Hz
Diameter of plate: 1.0 cm (parallel plates)
Gap: 3.0 mm
Distortion angle: Set by automatic strain control
Measuring temperature range: −20° C.-200° C.

In the present invention, the storage modulus is determined with the unit of “dyn/cm²” which can be converted as 1 dyn/cm²=1×10⁻¹ N/m². The viscosity η is determined with the unit of “poise” which can be converted as 1 poise=1×10⁻¹ Ps·s.

The clear toner which has a storage modulus G′ of the above-mentioned range at 60° C. can be obtained, for example, by incorporating a resin prepared by employing a polymerizable monomer called as a polycarboxylic acid monomer having a plurality of carboxyl groups in the side chain, when designing a resin which constitutes the clear toner. Namely, it is supposed that, by incorporating a resin produced by employing a polycarboxylic acid monomer in the binder resin, a hydrogen bond is moderately formed between the molecules which constitute the resin through a carboxyl group, whereby an easily aggregating condition of the moleciles constituting the resin has been formed.

Namely, the elasticity of the clear toner layer is supposed to be improved due to the formation of pseudo aggregation state of the molecules constituting the binder resin through a carboxyl group under a temperature condition of around 60° C. where the clear toner layer has been cooled. Consequently, even when a mechanical shock is applied to the clear toner layer, the clear toner layer is not deformed by the shock since the shock is absorbed due to the action of elastic power, whereby the flatness of the clear toner layer surface is maintained, and gloss is ensured.

Therefore, when the storage modulus G′ at 60° C. of the clear toner is smaller than 1×10⁶ N/m², the clear toner layer cannot fully absorb the shock, and is easily deformed to lose the flatness with the shock. Thus, the gloss is difficult to be ensured.

On the contrary, when the storage modulus G′ at 60° C. of the clear toner is larger than 1×10⁸ N/m², the clear toner layer can fully absorb the shock, and the deformation of the clear toner layer can be more surely avoided. However, such a toner layer must be melted at a higher temperature. Therefore more energy is needed. Also, the constituting member of the device is needed to convey the image print while being in contact with the higher temperature image print. Accordingly, the deterioration of the constituting member is supposed to be enhanced. Further, since the adhesion with belt member tends to become too strong, it may become difficult to evenly and smoothly peel the print from the belt member, which may cause a conveyance error in the device.

The “glossiness” as used in the present invention is a quantitated value of the extent of reflection from the transfer material surface obtained when the transfer material on which a clear toner layer is formed under a prescribed condition is irradiated with light. The glossiness can be determined, for example, according to the following procedure. Namely, the value obtained by measuring the surface of the clear toner layer which is formed by covering whole the transfer material surface with a clear toner, according to the method of “JIS/Z8741 1983 method 2”, using a glossiness measuring device (a glossiness meter) GMX-203 (produced by MURAKAMI COLOR RESEARCH LABORATORY Co., Ltd.) with an incident angle of 20° is defined as a glossiness.

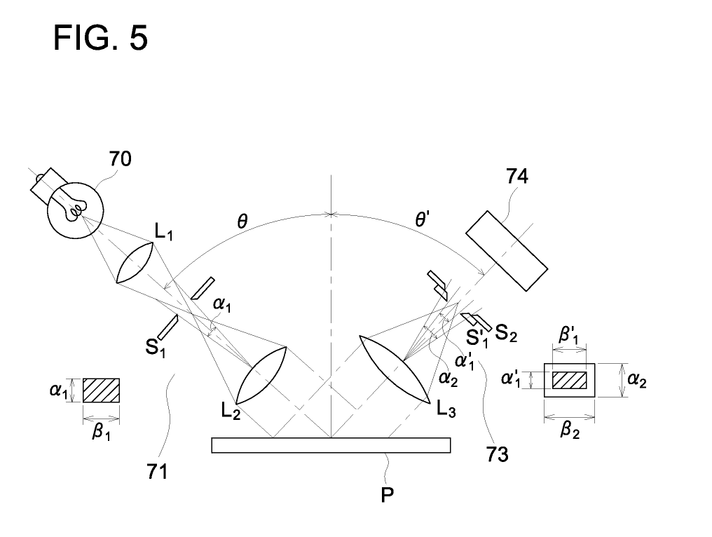

A conceptual diagram of a glossiness measuring devices (gross meter) is shown in FIG. 5. In a gloss meter, light is emitted by light source 70 and irradiated sample (transfer material on which the clear toner layer was formed) P through optical system 71. The light reflected from transfer material P is received by photoreceiver 74 through optical system 73.

In the figure, S1 and S2 each are a slit. Further, α1 is an opening angle of an optical image, and β1 is an opening angle in a vertical plane, α2 is an opening angle of a photoreceiver, and β2 is an opening angle in a vertical plane. Glossiness G is represented by the following formula, provided that, when the incident angle is a prescribed angle θ as shown in the figure, the luminous flux of the specular reflection from sample plane (transfer material on which the clear toner layer was formed) P is expressed as φ, and the luminous flux of the reflection from a standard plane is expressed as φs.

G=(φ/φ)×(glossiness of used standard plane)

Here, the glossiness of the used standard plane is 100.0. Therefore, the glossiness is represented by a value of 100 or less. Namely, when the luminous flux of reflection increases, the glossiness G becomes closer to 100. In the present invention, the glossiness of the formed clear toner layer maintained 60 or more even when the number of print sheets exceeded 150,000 sheets, and thus the specular reflection of light on the transfer material was confirmed.

As mentioned above, with respect to the clear toner of the present invention, the viscosity η at 130° C. is 1×10¹ Pa·s or more, but 1×10² Pa·s or less, and the storage modulus G′ at 60° C. is 1×10⁶ N/m² or more, but 1×10⁸ N/m² or less. By having these viscosity values and storage modulus values, the clear toner of the present invention has a nature that the binder resin constituting the clear toner smoothly melts at around 130° C. while the binder resin is strongly fixed at around 60° C. It was supposed that, by locally providing a portion exhibiting a strong molecular bond, a binder resin exhibiting the abovementioned characteristic can be obtained. Namely, it was also supposed that, by locally providing portions exhibiting a strong molecular bond, the binder resin can be smoothly melted without being disturbed by the strong molecular bond, when the resin is heated, while a suitable strength is provided to the binder resin at around 60° C., when the resin is cooled, due to the effect of the locally provided portions exhibiting a strong molecular bond.

Specifically, binder resins having the following structures have been considered.

(1) A binder resin in which the following resin component is incorporated in a vinyl resin binder, the resin component being formed by polymerizing a radically polymerizable monomer containing a radically polymerizable monomer having two or more carboxyl groups represented by a polycarboxylic acid, for example, itaconic acid or maleic acid.
(2) A binder resin in which a polyester resin component formed by polycondensing a polycarboxylic acid and a polyalcohol is incorporated in a vinyl resin binder.
(3) A binder resin in which a multifunctional radically polymerizable monomer represented by Formula (I) is is incorporated as a crosslinking agent in a vinyl resin binder.

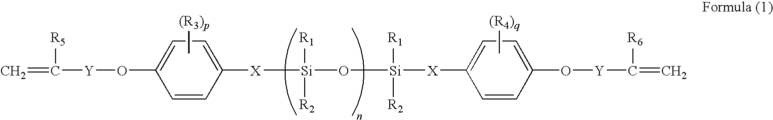

wherein R₁ and R₂ each represent an alkyl group having 1-12 carbon atoms which may have a substituent or an aryl group which may have a substituent; R₃ and R₄ each represent a hydrogen atom, a halogen atom, an alkyl group having 1-12 carbon atoms which may have a substituent, a cyclic hydrocarbon having 4-10 carbon atoms which may have a substituent, or an aryl group which may have a substituent; p and q each represent an integer of 0-4, R₅ and R₆ each represent a hydrogen atom, an alkyl group having 1-12 carbon atoms which may have a substituent; X represents an alkylene group having 1-10 carbon atoms or a single bond; Y represents an alkylene group having 1-4 carbon atoms; and n represents an integer of 1-20.

In the present invention, the clear toner is produced by using a polycarboxylic acid monomer of preferably 3-15% by mass and more preferably 5-10% by mass based on the total mass of the clear toner. As the polycarboxylic polymer, an itaconic acid monomer, a maleic acid monomer or a mixture thereof is preferable. It is specifically preferable that the above content range of itaconic acid monomer is used.

By incorporating an above resin component, a local pseudo aggregation structure is formed due to the effect of the hydrogen bond of such as an acid group, and, according to the effect of the pseudo aggregation structure, the internal aggregation power in the binder resin is supposed to be moderately increased. As a result, it is supposed that the clear toner smoothly melts at around 130° C. when the clear toner is heated, while a moderate strength is provided to the clear toner at around 60° C. when the clear toner is cooled.

The binder resin which constitutes the clear toner according to the present invention will further be explained.

The binder resin which constitutes the clear toner according to the present invention can be formed by employing a well-known polymerizable monomer which can be used together with the polymerizable monomer which forms the resin component mentioned above. For example, the binder resin can be formed in combination with one or more well-known vinyl monomers and a polymerizable monomer which can form the abovementioned resin component.

Specific examples of a polymerizable vinyl monomer will be shown below.

### (1) Styrene or Styrene Derivatives:

For example, styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecyl styrene;

### (2) Methacrylic Acid Ester Derivatives:

For example, methylmethacrylate, ethylmethacrylate, n-butylmethacrylate, isopropylmethacrylate, isobutylmethacrylate, t-butylmethacrylate, n-octylmethacrylate, 2-ethylhexylmethacrylate, stearylmethacrylate, laurylmethacrylate, phenylmethacrylate, diethylaminoethylmethacrylate and dimethylaminoethylmethacrylate;

### (3) Acrylate Derivatives:

For example, methylacrylate, ethylacrylate, isopropylacrylate, n-butylacrylate, t-butylacrylate, isobutylacrylate, n-octylacrylate, 2-ethylhexylacrylate, stearylacrylate, laurylacrylate and phenylacrylate;

### (4) Olefins:

For example, ethylene, propylene and isobutylene;

### (5) Vinyl Esters:

For example, vinyl propionate, vinyl acetates and vinyl benzoate;

### (6) Vinyl Ethers:

For example, vinyl methyl ether and vinyl ethyl ether;

### (7) Vinyl Ketones:

For example, vinyl methyl ketone, vinyl ethyl ketone and vinyl hexyl ketone;

### (8) N-Vinyl Compounds:

For example, N-vinyl carbazole, and N-vinyl indol and N-vinyl pyrrholidone; and

### (9) Others:

For example, vinyl compounds such as vinyl naphthalene and vinyl pyridine, acrylic acid derivatives or methacrylic acid derivatives such as acrylonirile, methacrylonirile and acrylamide.

As a polymelizable vinyl monomer forming the resin constituting the clear toner according to the present invention, those having an ionically dissociable group such as a carboxyl group, a sulfonic group or a phosphate group, are preferably employed, which will be shown below.

Examples of such a compound containing a carboxyl group include: acrylic acid, methacrylic acid, maleic acid, itaconic acid, cinnamic acid, fumaric acid, monoalkyl maleate and monoalkyl itaconate. Examples of such a compound containing a sulfonic acid group include: styrene sulphonic acid, allyl sulfosuccinic acid and 2-acrylamide-methylproane sulfonic acid. Examples of such a compound containing a phosphoric acid group include: acid phospho-oxyethylmethacrylate.

The multifunctional vinyl compounds shown below are preferably employed to form a resin having a cross-linking structure. Specific examples of multifunctional vinyl compounds will be shown below.

Ethylene glycol dimethacrylate, ethylene glycol diacrylate, diethyleneglycol dimethacrylate, diethyleneglycol diacrylate, triethylene glycol dimethacrylate, triethylene glycol diacrylate, neopentyl glycol dimethacrylate and neopentyl glycol diacrylate.

The producing method of a clear toner according to the present invention will be described.

The producing method of the particles composing the clear toner according to the present invention is not specifically limited and they can be produced with known producing methods of a toner used for the image formation via an electrophotographic method. They can be produced with a so called pulverization method containing the steps of kneading, pulverization, and classification. They can also be produced with a so called polymerization method (for example, emulsion polymerization method, a suspension polymerization method, and a polyester molecule elongation method) in which a polymerizable monomer is polymerized, at the same time, particle formation is carried out while controlling the shape and dimension of the particles.

Of these, uniform particle size distribution and shape distribution, and sharp electrostatic charge distribution is readily achieved for the clear toner produced by a polymerization method. The method of producing toner via a polymerization method contains, for example, a process to form resin particles by a polymerization reaction such as suspension polymerization and emulsion polymerization. Of these, specifically preferable is a clear toner produce via an association process in which resin particles are prepared by a polymerization method, followed by coagulation and fusion of the resin particles to form toner particles.

When producing a clear toner according to the present invention through an association process, a clear toner having a core/shell structure which simultaneously enables low-temperature fixability and thermal storage stability may also be produced. A clear toner having a core/shell structure can be produced by, forming core with resin particles having a low softening temperature or glass transition temperature, first, followed by aggregating and coagulating resin particles having a high softening temperature or glass transition temperature on the core surface to form a clear toner having a core/shell structure.

Regarding the clear toner having a core/shell structure, it is preferable to form a core employing a resin which melts at a lower temperature while providing a moderate internal cohesive force. By employing a resin which exhibits such a property, when the clear toner exfoliates from the belt member after heating and cooling while the clear toner layer surface is in contact with the belt member, the clear toner layer hardly fractures, whereby a clear toner layer with high durability can be obtained. Moreover, hot offset due to the clear toner fractured in the melted state will not occur, whereby a favorable clear toner layer formation can be carried out.

Further, by forming the shell employing a resin exhibiting a high glass transition temperature, no interparticle adhesion occurs and the clear toner can be stored under a stable condition, even when the clear toner is stored under a thermally unstable environment such as a high temperature/high humidity condition for a long period of time.

There will be described a preparation method of the clear toner according to the present invention by a process of emulsion association, as an example of preparation method of the clear toner according to the present invention. Preparation of a Clear Toner by a Process of Emulsion association is conducted, for example, through the following steps:

(1) Preparation step of resin particle dispersion
(2) Coagulation/fusion step of resin particle
(3) Ripening step
(4) Cooling step
(5) Washing step
(6) Drying step
(7) External additive treatment step
Hereafter, each process will be explained.

### (1) Preparation Step of Resin Particles Dispersion

In this step (1), polymerizable monomers by which the resin constituting the clear toner are fed into an aqueous medium and dispersed, and allowed to polymerize to form resin particles of an approximately 100 nm size. The expression “aqueous medium” refers to a medium which is composed of 50-100% by mass of water and 0-50% by mass of a water-soluble organic solvent. Examples of such a water-soluble organic solvent include methanol, ethanol, isopropanol, butanol, acetone and methyl ethyl ketone.

As a preferable example of the polymerization processing performed in this process, for example, into an aqueous media containing a surfactant at a concentration of not more than the critical micelle concentration (CMC), a polymerizable monomer solution in which, for example, a wax or a charge control agent may be added if necessary, is added, and a mechanical energy is added to form droplets. Subsequently, resin particles are formed by adding a water-soluble polymerization initiator to conduct a polymerization reactions in the droplets. An oil-soluble polymerization initiator may be contained in the droplets. In this process, it becomes essential to give a mechanical energy to compulsorily perform emulsification (forming the liquid droplet). Examples of a device to apply mechanical energy include devices which give a strong stirring energy or a strong ultrasonic vibration energy such as: a homomixer, an ultrasonic homogenizer and a Manton-Gaulin homogenizer.

### (2) Coagulation/Fusion Step of Resin Particles

In this step (2), resin particles prepared in the foregoing step are allowed to coagulate in an aqueous medium and to fuse the coagulation interface by heating to prepare parent particles of a clear toner. In this step, a coagulant of an alkali metal salt or an alkaline earth metal salt such as magnesium chloride is added to an aqueous medium containing resin particles to coagulate these particles. Subsequently, the aqueous medium is heated at a temperature higher than the glass transition temperature of the resin particles to allow coagulation to proceed and to allow coagulated resin particles to fuse. When allowing coagulation to proceed and reach the targeted particle size, a salt such as sodium chloride is added to stop coagulation.

### (3) Ripening Step

Subsequent to the foregoing coagulation/fusion step, the reaction system is subjected to a heat treatment to ripen parent particles of the clear toner particles until the clear toner particles reach the targeted average circularity. This ripening step is also called as the shape controlling step.

### (4) Cooling Step

In this cooling step, a dispersion of clear toner parent particles is subjected to a cooling treatment (rapid cooling treatment). A cooling treatment is conducted at a cooling rate of 1 to 20° C./min. A cooling treatment is not specifically limited and examples thereof include a method in which a cooling medium is introduced from the outside of a reactor and a method in which a cooling water is fed directly to the reaction system.

### (5) Washing Step

This washing step comprises a solid/liquid separation step of separating particles from the clear toner particle dispersion which was cooled to a prescribed temperature in the foregoing step and a subsequent washing step to remove any attached surfactant, coagulant or the like from the clear toner parent particle which is a cakey aggregate called as a wet toner cake obtained by the solid/liquid separation by washing.

Washing is conducted with water until the electric conductivity of the filtrate reaches a level of 10 μS/cm. Examples of methods for a solid/liquid separation include a centrifugal separation method, a reduced-pressure filtration method using a Nutsche funnel and a filtration method using a filter press. However, the present invention is not limited thereto.

(6) Drying Step

In this drying step, washed clear toner parent particles are dried to obtain dried clear toner parent particles. Examples of a dryer usable in this step include a spray dryer, a vacuum freeze-dryer and a reduced-pressure dryer. However, it is preferred to use a standing plate dryer, a mobile plate dryer, a fluidized-bed dryer, a rotary dryer or a stirring dryer.

The moisture content of dried clear toner parent particles is preferably not more than 5% by mass, and more preferably not more than 2% by mass. In cases when dried clear toner parent particles are aggregated by a weak attractive force between particles to form an aggregate, such an aggregate may be subjected to a disintegration treatment. There are usable mechanical disintegrators such as a jet mill, a HENSCHEL MIXER, a coffee mill or a food processor.

### (7) External Additive Treatment Step

In this external additive treatment step, external additives or a lubricant is added to dried clear toner parent particles. Clear toner parent particles which were subjected to the drying step may be used as toner particles, but addition of external additives can enhance the electrostatic-charging property, fluidity and cleaning property. External additives usable in the present invention include, for example, organic or inorganic particles and aliphatic metal salts. An external additive is added preferably in an amount of 0.1 to 10.0% by mass, and more preferably 0.5 to 4.0% by mass. A variety of additives may be combined. Examples of a mixing device, used to add external additives include a turbuler mixer, a HENSCHEL MIXER, a Nautor Mixer, a V-type mixer and a coffee mill.

According to the foregoing steps, the clear toner according to the present invention can be produced via an emulsion association method.

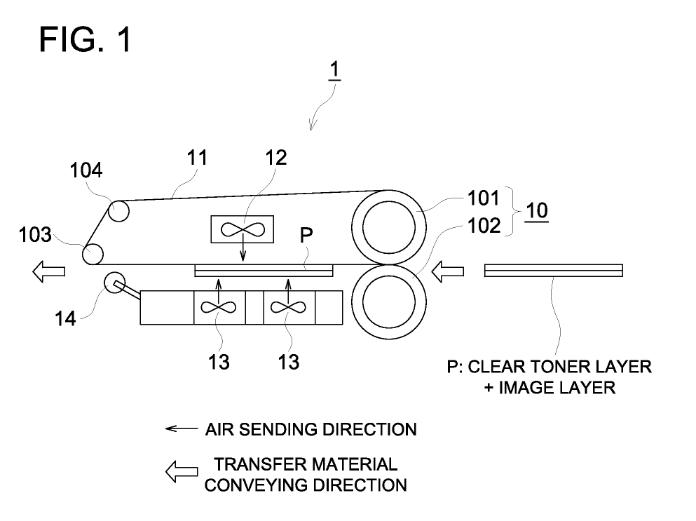

Next, a gloss providing device will be explained, in which, the clear toner according to the present invention is provided on all over the transfer material on which an image is formed, and the clear toner is heated and then cooled while the clear toner is in contact with a belt member to form a glossy surface on all over the transfer material. FIG. 1 is a schematic diagram showing a typical example of a gloss providing device which forms a glossy surface all over the image surface employing the clear toner according to the present invention.

The gloss-providing device 1 shown in FIG. 1 has at least the following constitutions.

(1) Heating and pressing device 10 in which transfer material P on which the clear toner is provided all over the image is heated while being pressed;
(2) Belt member 11 which contacts the clear toner layer which is melted by the heating and pressing device 10 to form a contact surface between the clear toner surface, and conveys the transfer material P;
(3) Cooling fans 12 and 13 which supply cooling air to the transfer material P which is being conveyed while being in contact with belt member 11;
(4) Conveyance roll 14 which conveys the transfer material P on which the clear toner layer is fixed by cooling with the air supplied from cooling fans 12 and 13;

Hereafter, each constitution will be specifically explained.

Heating/pressurizing member 10 will be explained, first.

In heating/pressurizing member 10 shown in FIG. 1, transfer material P on which a clear toner layer is provided is inserted between a pair of rolls 101 and 102 driven at a constant speed to be carried and transfer material P is heated and pressurized. Namely, the clear toner supplied all over the transfer material P is melted by the heat supplied from heating/pressurizing member 10 and the melted clear toner can form a clear toner layer having a smooth surface without steps by being pressurized. By providing a heat source in the center of one of the pair of rolls 101 and 102, or both, the heat source can heat so that the clear toner supplied on all over the transfer material is melted. The pair of rolls 101 and 102 preferably have a structure in that the two roll are pushed each other so as the surely pressurize the melted clear toner between the rolls.

The gloss-providing device 1 shown in FIG. 1 may have a structure in which roll 101 works as a heating roll and roll 102 works as a pressurizing roll, with respect to the electrical consumption and working efficiency, by which sufficient heating and pressurizing are possible. On the surface of one of or both of roll 101 and roll 102 constituting the heating/pressurizing member 10, a silicone rubber or a fluorine containing rubber may be provided, and the width of the nip region where heating and pressurizing are conducted is preferably 5 mm-30 mm.

Heating roll 101 has a structure in which an elastic layer containing, for example, a silicone rubber is coated on a surface of a metallic core made of, for example, aluminum to have a predetermined outer diameter. In the inside of heating roll 101, for example, a 300-500 W halogen lamp is installed as a heat source to heat the heating roll 101 from inside so that the surface temperature reaches the predetermined temperature.

Pressurizing roll 102 has a structure in which an elastic layer containing, for example, a silicone rubber is coated and covered by, for example, a tube of PFA (tetrafluoroethylene/perfluoroalkyl vinylether copolymer) as a separator layer, on a surface of a metallic core made of, for example, aluminum to have a predetermined outer diameter. Also in the inside of pressurizing roll 102, for example, a 300-500 W halogen lamp may be installed as a heat source to heat the pressurizing roll 102 from inside so that the surface temperature reaches the predetermined temperature.

In the heating/pressurizing member 10, transfer material P on which the clear toner is provided on all over the image forming surface is introduced between the rolls which are pushed with each other (nip portion) so that the surface provided with the clear toner is on the heating roll 101 side, and while it passes through the portion where rolls 101 and 102 are pushed with each other, the clear toner is melted by the heat and simultaneously fused onto the image to form a clear toner layer of the predetermined thickness.

Next, the belt member 11 will be explained. As shown in FIG. 1, belt member 11 has an endless belt structure which is supported by heating roll 101 and other plural belts including heating belt 101, namely, rolls 101, 103 and 104, so as to be rotatable. As mentioned above, the belt member 11 is rotatably set up by plural rolls including heating roll 101, release roll 103, and driven roll 104, and driven to rotate at a predetermined speed by heating roll 101 which is rotated by a drive source which is not illustrated. Thus, belt member 11 is driven to rotate at a predetermined process speed without wrinkle by the drive forth due to heating roll 101 and a tension provided by release roll 103 and driven roll 104.

Since the belt member 11 forms a contact surface with the melted clear toner surface and the transfer material P is conveyed through the melted clear toner surface, it can be produced with a known material which possesses a certain extent of heat resistance and mechanical strength. Specifically, for example, heat-resistant film resins such as polyimide, polyether polyimide, PES (polyethersulfone) and PFA (tetrafluoro ethylene-perfluoroalkyl vinylether copolymer) are cited. It is preferable that, a release layer containing a fluorine containing resin such as PTFE (polytetrafluoroethylene) or PFA, or a silicone rubber is formed on at least a surface where the clear toner layer contacts of the abovementioned heat-resistant film resin.

The thickness of belt member 11 is not specifically limited if a transfer material can be conveyed through a contact surface with the melted clear toner surface, and a belt member with a well known thickness is usable. Specifically, the thickness of a heat-resistant film resin is preferably 20 μm-80 μm, the thickness of a release layer is preferably 10 μm-30 μm, and the total thickness is preferably 20 μm-110 μm.

Next, cooling fans 12 and 13 will be explained. The gloss-providing device 1 shown in FIG. 1 has cooling fan 12 between heating roll 101 and release roll 103 in the inside of foregoing belt member 11, and has cooling fan 13 between pressurizing roll 102 on the outside of belt member 11 and conveyance assist roll 14. Here, the outer surface of belt member 11 is a surface which conducts support and conveyance of transfer material P while it is adhered with transfer material P through the melted clear toner surface to form a contact surface.

In gloss-providing device 1 of FIG. 1, the clear toner layer is melted by aforementioned heating/pressurizing member 10 and pressed to attain a predetermined thickness. The transfer material P is conveyed while the clear toner layer is adhered on the outer surface of belt member 11, and simultaneously, the clear toner layer is cooled to solidify. Cooling fans 12 and 13 compulsorily cools the transfer material P having the clear toner layer while being conveyed. Gloss-providing device 1 may be equipped with a heat sink or a heat pipe for cooling in connection with cooling fans 12 and 13. By means of such a heat sink or heat pipe for cooling, the cooling of the melted clear toner layer can be promoted.

The solidification of the clear toner layer of the transfer material A under conveyance by the belt member 11 is promoted by forced cooling by the abovementioned cooling fans 12 and 13, and the clear toner layer is fully cooled and solidified when the clear toner layer is conveyed near the end where conveyance assist roll 14 and release rolls 103 are provided. Then, the transfer material P is exfoliated from the belt member 11, according to the following procedures.

The transfer material P conveyed near the end is conveyed while supported by belt member 11 through the clear toner layer. In this condition, conveyance assist roll 14 becomes in touch with the back surface of transfer material P to assist the conveyance. When transfer material P is conveyed to release roll 103 while supported by conveyance assist roll 14 from backside, belt member 11 changes the conveyance direction toward driven roll 104 (upward in the figure). At this moment, transfer material P exfoliates from transfer material 11 according to the stiffness of transfer material 11 itself and discharged from gloss providing device 1 by the assistance of conveyance assist roll 14.

According to the abovementioned procedures, gloss providing device 1 provides the clear toner on all over the transfer material where an image is formed, heat and pressurize the provided toner to form a melted clear toner layer having a predetermined thickness, cool and solidify the clear toner layer while conveying transfer material P on which melted clear toner layer is formed by the belt member, exfoliate transfer material P from belt member 11 after the clear toner layer solidifies, and discharges transfer material P from the device.

In gloss providing device 1, exfoliation of transfer material P from belt member 11 is conducted with the aide of conveyance assist roll 14 and release roll 103. It is also possible to use a exfoliation claw placed between belt member 11 and transfer material P, instead of release roll 103. As mentioned above, in the present invention, preparations method of an image on which a clear toner layer is formed is not specifically limited and images formed by a known image forming method such as an electrophotographical method, an inkjet method or a silver-salt photographic method are usable.

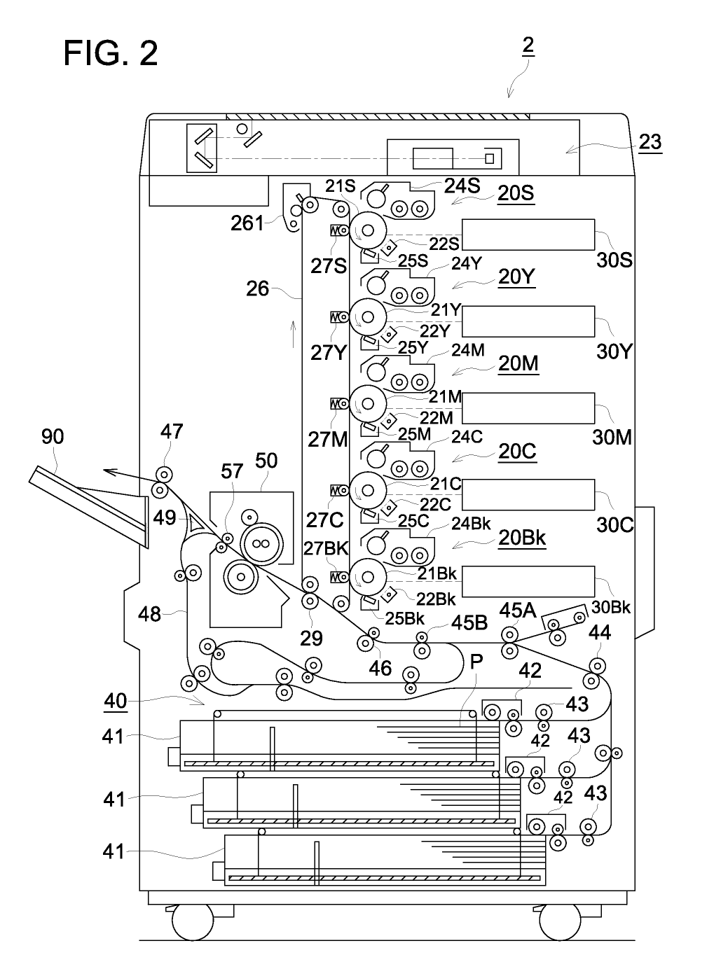

FIG. 2 is a cross-sectional configuration diagram of an image forming device which forms a full color toner image and also a clear toner layer all over the full color toner image. The image forming devices shown in FIG. 2 has a different configuration from that of gloss providing device 1, however, fixing device 50 which heats and pressurizes a clear toner to form a clear toner layer in the same way as gloss providing device 1 of FIG. 1.

Image forming device 2 shown in FIG. 2 is commonly called as a tandem type color image forming device and contains clear toner layer forming unit 20S, a plurality of toner image forming units 20Y, 20M, 20C and 20Bk, intermediate transfer belt 26, sheet feeder 40 and fixing device 1.

Image reading device 23 is placed on the upper part of image forming device 2. A manuscript placed on a manuscript holder is image-scanning-exposed to light emitted by an optical system of a manuscript image-scanning exposure device in image reading device 23 to read the image in a line image sensor. The analog signals photoelectrically converted by the line image sensor are input to light exposure devices 30S, 30Y, 30M, 30C and 30Bk, after conducting analog processing, A/D conversion, a shading correction and image compression processing in control section.

In the present invention, in naming a component generically, the reference numerals in which alphabet subscript is omitted are used, and in pointing out discrete components, the reference numerals which is attached with the subscript of S (clear toner), Y (yellow), M (magenta), C (cyan), and Bk (black) are used.

Clear toner supply unit 20S which supplies a clear toner all over transfer material employing the clear toner according to the present invention, yellow image forming unit 20Y which performs yellow toner image formation, magenta image forming unit 20M which performs magenta toner image formation, cyan image forming unit 20C which performs cyan toner image formation, and black image forming unit 20Bk which forms black toner image formation, each contain a charging electrode 22 (22S, 22Y, 22M, 22C, 22Bk), an exposing member 30 (30S, 30Y, 30M, 30C, 30Bk), a developing member 24 (24S, 23Y, 24M, 24C, 24Bk) and a cleaning member 25 (25S, 25Y, 25M, 25C, 25Bk) each located around a drum shaped photoreceptor 21 (21S, 21Y, 21M, 21C, 21Bk) as an image carrier.

Photoreceptor 21 contains an organic photoreceptor in which a photoreceptor layer containing a resin in which an organic photoconductor is incorporated is formed on a peripheral surface of a drum shaped metal support, which is placed extending toward the width direction of transfer material P (a direction perpendicular to the paper sheet in FIG. 2). As a resin for the photoreceptor layer formation, a well-known resin for forming a photoreceptor layer such as polycarbonate is used. In the embodiment shown in FIG. 2, an example in which a drum shaped photoreceptor 21 is used, however, the photoreceptor is not limited thereto and a belt shaped photoreceptor may be used.

Developing member 24 each include a two-component developer containing each of a clear toner according to the present invention (S), a yellow toner (Y), a magenta toner (M), a cyan toner (C), and a black toner (Bk), and a carrier. A two-component developer is constituted of color toners of each color each containing a carrier having ferrite particles on which an insulating resin is coated, a colorant such as a well-known binder resin, a well-known pigment or carbon black, a charge control agent, silica, or titanium oxide.

As for a carrier, the average particle diameter is 10-50 μm and the saturation magnetization is 10-80 emu/g. The average particle diameter of the toner is 4-10 μm. The electrification characteristic of the toner used in the image forming device shown in FIG. 2 including the clear toner according to the present invention is preferably negative electrification characteristic and the amount of average electric charge is preferably −20 to −60 mC/g. The mixing ratio of the toner and the carrier in a two-component developer is adjusted so that the content of the toner is 4-10% by mass.

Intermediate transfer belt 26 which is an intermediate transfer medium is rotatably supported by plural rolls. Intermediate transfer belt 26 is an endless belt exhibiting a volume resistance of preferably 10⁶-10¹²Ω·cm. Intermediate transfer belt 26 may be formed by a well-known resin, for example, polycarbonate (PC), polyimide (PI), polyamideimide (PAI), polyvinylideine fluoride (PVDF), or a tetrafluoroethylene—ethylene copolymer (ETFE). The thickness of intermediate transfer belt 26 is preferably 50-200 μm.

Each color image formed on each photoreceptor 21 (21S, 21Y, 21M, 21C, 21Bk) by each of clear toner image forming unit, and toner image forming units 20Y, 20M, and 20C is sequentially transferred on to intermediate transfer belt 26 employing primary each transfer roller 27 (27S, 27Y, 27M, 27C, and 27Bk) (primary transfer), whereby a clear toner image and a combined full color image is formed. After the images are transferred, each photoreceptor of 21Y, 21M, 21C and 21Bk is subjected to cleaning by each cleaning member 25 (25S, 25Y, 25M, 25C, 25Bk) to remove residual toner.

Transfer material P stored in storing member 41 (tray) in sheet feeder 40 is fed to first feeding member 42 and conveyed through teeing rolls 43, 44, 45A, 45B, and resist roll 46 (second feeding member) to secondary transfer roll 29, where the clear toner image and the full color image are transferred (secondary transfer).

The three vertically arrayed storing members 41 in th lower portion of image forming device 2 were provided with the same number since these three members have almost the same structure. Also, the three vertically arrayed feeding members 42 were provided with the same number since the structures are almost the same. Storing members 41 and feeding members 42 in all are named as sheet feeder 40.

The clear toner image and the full color image transferred on transfer material P are fixed on transfer material P by fixing unit 50 which enables heating and pressurizing the toner to melt and solidify in the same manner as in gloss providing device 1 in FIG. 1, although the structure is different. Transfer material P is conveyed between a pair of conveying rolls 57, discharged through discharge rolls 47, and placed on a discharge tray which is outside of the image forming device.

After transferring the clear toner layer and the full color toner image onto transfer material P using secondary transfer roll 29 and separating transfer material P by curvature separation, the residual toner is removed by cleaning member 261 for the intermediate transfer belt.

When a full color image having full color images on both surfaces of transfer material P each having a clear toner layer is formed, transfer material P is branched from the conveyance pass for discharging by branching plate 49, after the clear toner layer and the full color image formed on the first side surface of transfer material P are subjected to the melt/solidify treatment, to introduce into double surface conveyance pass 48 to convert the front side and the rear side and then conveyed again through feed roll 45B. Also on the second surface, a clear toner layer and full color images containing each color are formed using clear toner layer forming unit 20S and image forming unit of each color 20Y, 20M, 20C and 20Bk, followed by being subjected to a heating/pressurizing treatment using fixing unit 1 and discharging out of the image forming device using discharging rolls 47. Thus, full color toner images on both surfaces of each of which, gloss is provided by forming clear toner layers.

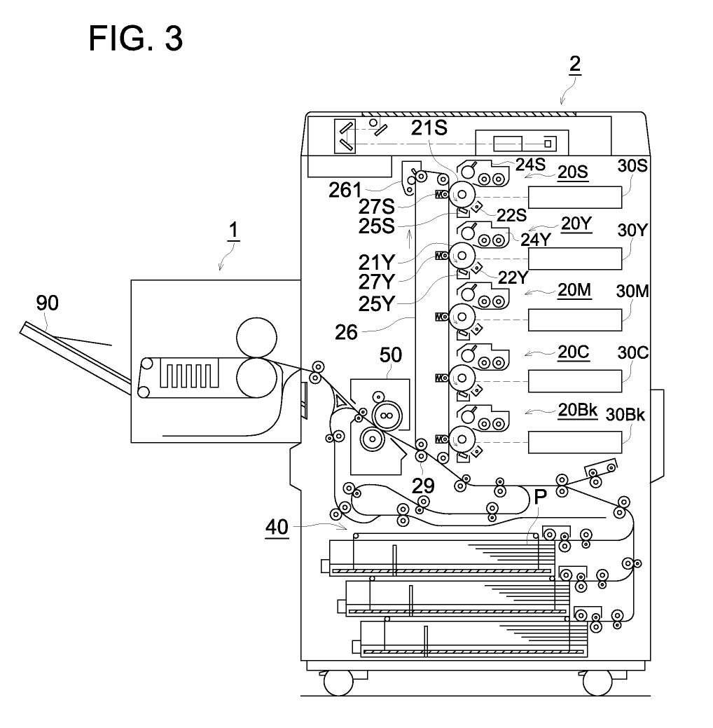

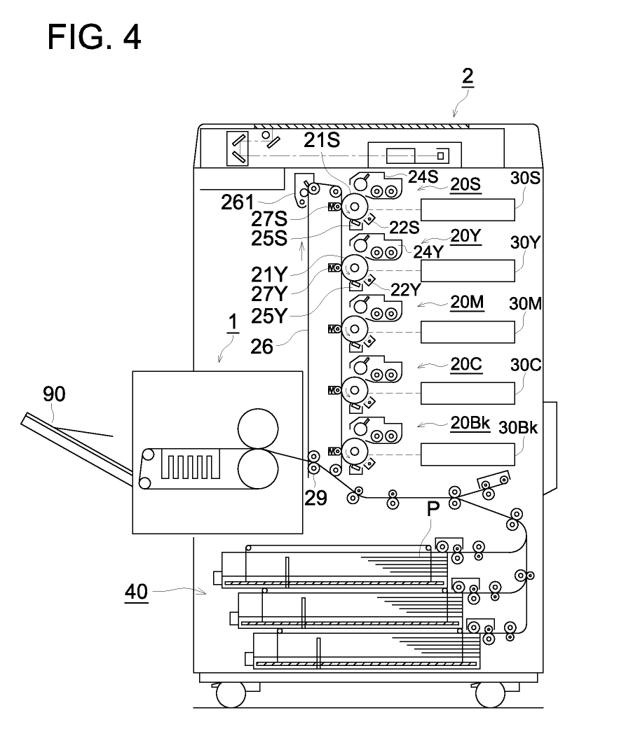

As mentioned above, a full color image having a glossy surface all over transfer material P can be formed using the image forming device shown in FIG. 2. In the present invention, gloss providing device 1 can be arranged to the image forming device 2 of FIG. 2, in the manner as shown in FIGS. 3 and 4. Here, FIGS. 3 and 4 are schematic diagrams showing examples of a device in which a gloss providing device is installed in the image forming device of FIG. 2. In FIG. 3, illustrated is a image forming device in which gloss providing device 1 is installed at the position of discharging member 90 of image forming device 2, in which an image print P fixed in fixing member 50 installed in image forming device 2 is further treated in gloss providing device 1 to further fix the clear toner layer, whereby a flat and glossy clear toner layer also having stiffness can be provided. Such an image is preferable as an outdoor poster since the fixing strength of the toner image is also increased.

In FIG. 4, illustrated is an image forming device in which gloss providing device 1 is installed at the position of fixing device 50 of FIG. 2, in which the clear toner layer transferred on transfer material P by secondary transfer roll 29 and the full color toner image are simultaneously fixed by gloss providing device 1. The image forming device shown in FIG. 4 is preferable because gloss providing device 1 is installed inside the device, whereby a compact device is achieved.

The transfer material which can form a glossy image employing the clear toner according to the present invention also called as an imaging support is not specifically limited, if image forming via a well known method and formation and support of the clear toner layer are possible. As the transfer material usable in the present invention, well known materials, for example, a regular paper from a thin paper to a thick paper, a fine quality paper, and an art paper, a printing paper, such as a coated paper, a commercial Japanese paper, a plastic film for an over head projector and a cloth are cite.

### EXAMPLES

The embodiments of the present invention will now be specifically explained using examples, however, the present invention is not limited thereto. The “part” or “parts” used in the following description represents “mass part” or “mass parts”, respectively.

1. Preparation of Clear toners 1-12
(1) Preparation of Clear toner 1
(a) Preparation of Resin particles 1

In a reactions vessel equipped with an agitator, a temperature sensor, a condenser tube, and a nitrogen introduction equipment, 7.08 mass parts of an anionic surfactant (sodium dodecylbenzenesulfonates: SDS) was dissolved in 2760 mass parts of ion-exchanged water to obtain a surfactant aqueous solution. The temperature of the surfactant aqueous solution was raised to 80° C. under a nitrogen gas stream while agitating the surfactant aqueous solutions at a mixing rate of 230 rpm.

On the other hand, the following compounds were mixed and dissolved by heating the mixture at 80° C. to prepare a mixed solution of monomers.

| | |
|---|---|
| Styrene | 140 mass parts |
| n-butyl acrylate | 85 mass parts |
| Itaconic acid | 50 mass parts |

Next, employing a mechanical dispersion apparatus having a circulatory pathway, the surfactant aqueous solution and the monomer mixed solution which were heated at 80° C. were mixed and dispersed to obtain a dispersion of emulsified particles having uniform diameters of dispersed particles. Then, a solution prepared by dissolving 0.84 mass part of potassium persulfate (KPS) in 200 mass parts of ion-exchange water was added, and heated at 80° C. while agitating for 3 hours to conduct a polymerization reaction, followed by cooling to 40° C. Thus Resin particle dispersion 1″ was obtained.

### (b) Preparation of Resin Particles 2

In a reactions vessel equipped with an agitator, a temperature sensor, a condenser tube, and a nitrogen introduction equipment, 7.08 mass parts of an anionic surfactant (sodium dodecylbenzenesulfonates: SDS) was dissolved in 2760 mass parts of ion-exchanged water to obtain a surfactant aqueous solution. The temperature of the surfactant aqueous solution was raised to 80° C. under a nitrogen gas stream while agitating the surfactant aqueous solutions at a mixing rate of 230 rpm.

On the other hand, the following compounds were mixed and dissolved by heating the mixture at 80° C. to prepare a mixed solution of monomers.

| | |
|---|---|
| Styrene | 130 mass parts |
| n-butyl acrylate | 50 mass parts |
| Methacrylic acid | 15 mass parts |
| Paraffin wax “HNP-57” (produced | 65 mass parts |
| by NIHON SEIRO Co., Ltd.) | |

Next, employing a mechanical dispersion apparatus having a circulatory pathway, the surfactant aqueous solution and the monomer mixed solution which were heated at 80° C. were mixed and dispersed to obtain a dispersion of emulsified particles having uniform diameters of dispersed particles.

Then, a solution prepared by dissolving 0.84 mass part of potassium persulfate (KPS) in 200 mass parts of ion-exchange water was added, and heated at 80° C. while agitating for 3 hours to conduct a polymerization reaction, followed by cooling to 40° C. Thus a resin particle dispersion was obtained.

Further, a solution in which 8 mass parts of potassium persulfate (KPS) and 10 mass parts of 2-chloroethanol were dissolved in 240 mass parts of ion-exchanged water was added into the above resin particle dispersion. After 15 minutes, a mixture of the following compounds was added dropwise at 80° C. over 120 minutes into the resin particle dispersion.

| | |
|---|---|
| Styrene | 380 mass parts |
| n-butyl acrylate | 120 mass parts |
| Methacrylic acid | 55 mass parts |

After adding the mixture, the product was heated and agitated for 60 minutes to conduct a polymerization reaction, followed by cooling to 40° C. Thus Resin particle dispersion 2 was obtained.

### (c) Preparation of Clear Toner Parent Particles 1

In a reactions vessel equipped with an agitating equipment, a temperature sensor, a condenser tube, and a nitrogen introduction equipment,

| | |
|---|---|
| Resin particles 1 | 120 mass parts |
| | (in terms of solid content) |
| Resin particles 2 | 1200 mass parts |
| | (in terms of solid content) |
| Ion-exchange water | 2000 mass parts |

were installed and agitated. After adjusting the temperature of the liquid at 30° C., the pH value of the liquid was adjusted by adding a 5 mol/l sodium hydroxide solution.

Subsequently, an aqueous solution prepared by dissolving 35 mass parts of magnesium chloride hexahydrate in 35 mass parts of ion-exchanged water was added over 10 minutes while agitating at 30° C. After 3 minutes, the temperature was started to raise, and the temperature was raised to 90° C. in 60 minutes. While keeping the temperature at 90° C., aggregation and fusion of the particles were continued. In this state, using MUTISIZER 3 (produced by BECKMAN COULTER), the particle diameter of the particles obtained by the aggregation and fusion was measured, and, when the volume median diameter of the particles increased to 5.5 μm, an aqueous solution obtained by dissolving 150 mass parts of sodium chloride in 600 mass parts of ion-exchanged water was added to stop the aggregation of the particles.

After aggregation was stopped, the temperature of the liquid was kept at 98° C., while agitating, for ripening. While ripening, the fusion was proceeded so that Resin particles 1 locate in inside of the aggregated particles and Resin particles 2 locate near the surface of the aggregated particles, until the average circularity became 0.965 by measuring “FPIA2100 (produced by SYSMEX Corp.)”. Thus Clear toner parent particles 1 were formed.

Then, the liquid was cooled to 30° C., the pH value of the liquid was adjusted to 2 using hydrochloride, and agitation was stopped.

Clear toner parent particles 1 obtained via the above processes were subjected to solid-liquid separation using a basket centrifuge MARK III type number 60×40 (produced by made from MATSUMOTO MACHINE CO., Ltd.), whereby a wet cake of Clear toner parent particles 1 was obtained.

This wet cake was washed using 45° C. ion-exchange water until the electrical conductivity of the filtrate obtained by the basket centrifuge became 5 μS/cm. Then, the cake was moved to a flash jet dryer (produced by SEISHIN ENTERPRISE Co., Ltd.), and dried until the water content decreased to 0.5% by mass. Thus, Clear toner parent particles 1 were obtained.

### (d) External Additive Treatment

The following external additives were added to obtained Clear toner parent particles 1, and the external additive treatment was carried out using a HENSCHEL MIXER produced by MITSUI MIIKE KOGYO Co., Ltd., whereby Clear toner 1 was obtained:

| | |
|---|---|
| Silica treated with hexamethyl silazane (an | 1.0 mass part |
| average primary particle diameter of 12 nm) | |
| Titanium dioxide treated with n-octylsilane | 0.3 mass part. |
| (an average primary particle diameter of 12 nm) | |

The external additive treatment using a HENSCHEL MIXER was carried out under the condition of, peripheral speed of the impeller: 35 m/second, treatment temperature: 35° C. and treatment duration: 15 minutes.

Clear toner 1 exhibited a viscosity η at 130° C. of 5.5×10¹ Pa·s and a storage modulus G′ at 60° C. of 1.3×10⁷ N/m².

(2) Preparation of Clear toner 2

Clear toner 2 was prepared in the same manner as Clear toner 1 except that the mixing ratio of Resin particles 1 and Resin particles 2 when these resin particles were aggregated was changed as follows:

| | |
|---|---|
| Resin particles 1 | 170 mass parts |
| | (in terms of solid content) |
| Resin particles 2 | 1150 mass parts |
| | (in terms of solid content) |

Clear toner 2 exhibited a viscosity η at 130° C. of 9.9×10¹ Pa·s and a storage modulus G′ at 60° C. of 2.5×10⁷ N/m².

(3) Preparation of Clear toner 3

Clear toner 3 was prepared in the same manner as Clear toner 1 except that the mixing ratio of Resin particles 1 and Resin particles 2 when these resin particles were aggregated was changed as follows:

| | |
|---|---|
| Resin particles 1 | 80 mass parts |
| | (in terms of solid content) |
| Resin particles 2 | 1240 mass parts |
| | (in terms of solid content) |

Clear toner 3 exhibited a viscosity η at 130° C. of 1.1×10¹ Pa·s and a storage modulus G′ at 60° C. of 8.8×10⁶ N/m².

(4) Preparation of Clear toner 4

Clear toner 4 was prepared in the same manner as Clear toner 1 except that following Resin particles 11 were used instead of Resin particles 1, where Resin particles 11 were prepared in the same manner as Resin particles 1 except that the amount of each polymerizable monomer was changed as follows:

| | |
|---|---|
| Styrene | 125 mass parts |
| n-butyl acrylate | 70 mass parts |
| Itaconic acid | 80 mass parts |

Clear toner 4 exhibited a viscosity η at 130° C. of 7.6 10¹ Pa·s and a storage modulus G′ at 60° C. of 1.0×10⁸ N/m².

(5) Preparation of Clear toner 5

Clear toner 5 was prepared in the same manner as Clear toner 1 except that following Resin particles 12 were used instead of Resin particles 1, where Resin particles 12 were prepared in the same manner as Resin particles 1 except that the amount of each polymerizable monomer was changed as follows:

| | |
|---|---|
| Styrene | 155 mass parts |
| n-butyl acrylate | 100 mass parts |
| Itaconic acid | 20 mass parts |

Clear toner 5 exhibited a viscosity η at 130° C. of 1.8×10¹ Pa·s and a storage modulus G′ at 60° C. of 1.1×10⁶ N/m².

(6) Preparation of Clear toner 6

Clear toner 6 was prepared in the same manner as Clear toner 1 except that Resin particles 11 were used instead of Resin particles 1 and the mixing ratio of Resin particles 11 and Resin particles 2 when these resin particles were aggregated was changed as follows:

| | |
|---|---|
| Resin particles 11 | 170 mass parts |
| | (in terms of solid content) |
| Resin particles 2 | 1150 mass parts |
| | (in terms of solid content) |

Clear toner 6 exhibited a viscosity η at 130° C. of 9.8×10¹ Pa·s and a storage modulus G′ at 60° C. of 9.9×10⁷ N/m².

(7) Preparation of Clear toner 7

Clear toner 7 was prepared in the same manner as Clear toner 1 except that Resin particles 12 were used instead of Resin particles 1 and the mixing ratio of Resin particles 12 and Resin particles 2 when these resin particles were aggregated was changed as follows:

| | |
|---|---|
| Resin particles 12 | 80 mass parts |
| | (in terms of solid content) |
| Resin particles 2 | 1240 mass parts |
| | (in terms of solid content) |

Clear toner 7 exhibited a viscosity η at 130° C. of 1.1×10¹ Pa·s and a storage modulus G′ at 60° C. of 1.2×10⁶ N/m².

(8) Preparation of Clear toner 8

Clear toner 8 was prepared in the same manner as Clear toner 1 except that the mixing ratio of Resin particles 1 and Resin particles 2 when these resin particles were aggregated was changed as follows:

| | |
|---|---|
| Resin particles 1 | 210 mass parts |
| | (in terms of solid content) |
| Resin particles 2 | 1110 mass parts |
| | (in terms of solid content) |

Clear toner 8 exhibited a viscosity η at 130° C. of 2.5×10² Pa·s and a storage modulus G′ at 60° C. of 4.7×10⁸ N/m².

(9) Preparation of Clear toner 9

Clear toner 9 was prepared in the same manner as Clear toner 1 except that the mixing ratio of Resin particles 1 and Resin particles 2 when these resin particles were aggregated was changed as follows:

| | |
|---|---|
| Resin particles 1 | 50 mass parts |
| | (in terms of solid content) |
| Resin particles 2 | 1270 mass parts |
| | (in terms of solid content) |

Clear toner 9 exhibited a viscosity η at 130° C. of 5.6×10⁰ Pa·s and a storage modulus G′ at 60° C. of 3.3×10⁶ N/m².

(10) Preparation of Clear toner 10

Clear toner 10 was prepared in the same manner as Clear toner 1 except that following Resin particles 13 were used instead of Resin particles 1, where Resin particles 13 were prepared in the same manner as Resin particles 1 except that the amount of each polymerizable monomer was changed as follows:

| | |
|---|---|
| Styrene | 105 mass parts |
| n-butyl acrylate | 50 mass parts |
| Itaconic acid | 120 mass parts |

Clear toner 10 exhibited a viscosity η at 130° C. of 8.8×10¹ Pa·s and a storage modulus G′ at 60° C. of 4.5×10⁸ N/m².

(11) Preparation of Clear toner 11

Clear toner 11 was prepared in the same manner as Clear toner 1 except that following Resin particles 14 were used instead of Resin particles 1, where Resin particles 14 were prepared in the same manner as Resin particles 1 except that the following polymerizable monomers were used:

| | |
|---|---|
| Styrene | 165 mass parts |
| n-butyl acrylate | 110 mass parts |

Clear toner 11 exhibited a viscosity η at 130° C. of 1.3×10¹ Pa·s and a storage modulus G′ at 60° C. of 5.4×10⁵ N/m².

(12) Preparation of Clear toner 12

The clear toner disclosed in JP-A No. 2002-341619 (aforementioned Patent document 2) was prepared in the following procedures. Namely, after sufficiently mixing the following compounds using HENSCHEL MIXER (produced by MITSUI MIIKE KOGYO Co., Ltd.), the mixture was melt-kneaded and then cooled using a twin-screw extruder/kneader PCM-30 (produced by IKEGAI Corp.) from which the discharge member was removed.

| | | |
|---|---|---|
| Polyester resin (linear polyester resin obtained from | 100 | mass parts |
| terephthalic acid/bisphenol A ethylene oxide adduct/ | | |
| cyclohexanedimethanol (molar ratio = 5:4:1)) | | |
| Pentaerythritol behenic ester | 6 | mass parts |
| charge control agent (a boron complex of dibenzylic | 1 | mass part |
| acid) | | |

After cooling the kneaded mixture by a cooling belt, the mixture was roughly pulverized by a feather mill, followed by further pulverizing to an average particle diameter of 9-10 μm using a mechanical pulverizer KTM (produced by KAWASAKI HEAVY INDUSTRIES, Ltd.). Further, the product was subjected to a pulverization treatment and a rough classification using a jet-pulverizer IDS (produced by NIPPON PNEWMATIC MFG. Co., Ltd.) to obtain particles of an average particle diameter of 5.5 μm. Subsequently, using the roughly classified power, Clear toner parent particles 12 having a median diameter of 5.5 μm were obtained employing a rotor classifier (turboplex classifier 100ATP produced by HOSOKAWA MICRON Corp.)

An external additive treatment employing HENSCHEL MIXER (produced by MITSUI MIIKE KOGYO Co., Ltd.) was carried out on prepared Clear toner parent particles 12 using the following external additives to obtain Clear toner 12.

| | |
|---|---|
| Silica treated with hexamethyl silazane | 1.0 mass part |
| (average primary particle diameter of 12 nm) | |
| Titanium dioxide treated with n-octyl silane | 0.3 mass part |
| (average primary particle diameter of 20 nm) | |

The external additive treatment using HENSCHEL MIXER was carried out under the condition of, peripheral speed of the impeller: 35 m/second, treatment temperature: 35° C. and treatment duration: 15 minutes.

Clear toner 12 exhibited a viscosity η at 130° C. of 8.0×10² Pa·s and a storage modulus G′ at 60° C. of 2.0×10⁸ N/m².

According to the above procedures, Clear toners 1-12 were prepared. The viscosity η at 130° C. and the storage modulus G′ at 60° C. of each of Clear toners 1-12 are shown in Table 1.

TABLE 1

| | VISCOSITY | STORAGE |
|---|---|---|
| CLEAR TONER | (η(130° C.)) | MODULUS |
| NO. | (Pa · s) | (G′ (60° C.)) |
| 1 | 5.5 × 10¹ | 1.3 × 10⁷ |
| 2 | 9.9 × 10¹ | 2.5 × 10⁷ |
| 3 | 1.1 × 10¹ | 8.8 × 10⁶ |
| 4 | 7.6 × 10¹ | 1.0 × 10⁸ |
| 5 | 1.8 × 10¹ | 1.1 × 10⁶ |
| 6 | 9.8 × 10¹ | 9.9 × 10⁷ |
| 7 | 1.1 × 10¹ | 1.2 × 10⁶ |
| 8 | 2.5 × 10² | 4.7 × 10⁷ |
| 9 | 5.6 × 10⁰ | 3.3 × 10⁶ |
| 10 | 8.8 × 10¹ | 4.5 × 10⁸ |
| 11 | 1.3 × 10¹ | 5.4 × 10⁵ |
| 12 | 8.0 × 10² | 2.0 × 10⁸ |

### 2. Evaluation

### 2-1. Preparation of Clear Toner Developer

A ferrite carrier having an average particle diameter of 40 μm covered with a methylmethacrylate regin was mixed with each of Clear toners 1-12 so that the content of each clear toner is 6% by mass. Thus Clear toner developers 1-12 which were two-component developers were prepared.

### 2-2. Evaluation Experiment

### (1) Evaluation Condition

Each of clear toner developers 1-12 was charged in gloss providing device 1 shown in FIG. 1, and a clear toner layer was formed on each of the transfer materials on which the same images were formed by each of the following commercially available image forming devices. The conditions for each of the gloss providing devices will be described later. As a transfer material, commercially available “OK TOP COAT+” produced by OJI PAPER Co., Ltd. (basis weight of 157 g/m², thickness of 131 μm) was used. As image forming devices used for the image forming, the following commercially available devices (a) to (c) were used, and 70,000 sheets by each image forming device, in total 210,000 sheets of transfer materials for evaluation were printed. Then, a continuous operation of 210,000 sheets was carried out using gloss providing device 1. The samples prepared by using Clear tones 1-7, which were within the scope of the present invention were designated as Examples 1-7, respectively, and the samples prepared by using Clear tones 8-12, which were outside of the scope of the present invention were designated as Comparative Examples 1-5, respectively.

Used image forming devices were as follows:

(a) Electrophotographic method: BIZHUB C353 (produced by Konica Minolta Business Technologies, Inc.)
(b) Inkjet method: Ink-jet printer PX-5800 (produced by SEIKO EPSON Corp.)
(c) Printing method: RISO digital screen plate maker SP400D (produced by RISO KAGAKU Corp.)

In the above continuous operation using gloss providing device 1, the image sheets were supplied to gloss providing device 1 so that the image sheet formed by each of above three image forming devices was sequentially supplied one by one, namely, the image prints were supplied, for example, in the order: an image print formed by Electrophotographic method→an image print formed by Inkjet method→an image print formed by Printing method, and so on, one by one.

The conditions for each gloss providing device 1 shown in FIG. 1 were set as follows:
(a) Amount of provided clear toner: 4 g/m²
(b) Material of belt member: polyimide film (thickness of 50 μm) on which a PFA layer (thickness of 10 μm) was provided
(C) Surface roughness (initial surface roughness): Ra 0.4
(d) Specifications of heating/pressurizing roll
   Heating roll: outer diameter of 100 mm, 10 mm thick aluminum support
   Pressurizing roll: outer diameter of 80 mm, 10 mm thick aluminum support having thereon 3 mm thick silicone rubber layer
   Heat source: halogen lamp is installed in heating roll and pressurizing roll (temperature is controlled by thermistor).
   Nip width between heating roll and pressurizing roll: 11 mm
(e) Set temperatures for heating roll and pressurizing roll Roll surface of heating roll: normally 155° C. (175° C. for Comparative examples 1 and 5)
   Roll surface of pressuring roll: 115° C.
(f) Temperature of transfer material at release roll: normally 50° C. (35° C. for Comparative example 4)
(g) Distance between nip portion of heating/pressurizing roll and release roll: 620 mm
(h) Conveyance speed of transfer material: 220 mm/second
(j) Evaluation environment: Normal temperature and normal humidity (temperature of 20° C., relative humidity of 50% RH).

### (2) Evaluation Items

The surface conditions of the belt member installed in gloss providing device 1 were examined by a commercially available laser beam microscope and the gloss of the clear toner layers provided on the images formed by each image forming device were evaluated at the beginning of printing (initial), after 100,000 sheets printing and after 210,000 sheets printing.

### <Deterioration State of the Surface of Belt Member>

The surface conditions of the belt member installed in gloss providing device 1 were examined by a commercially available laser beam microscope VK-9500 (produced by KEYENCE Corp.) at the beginning of printing (initial), after 100,000 sheets printing and after 210,000 sheets printing. More, specifically, the surface roughness of the belt member was determined by analyzing a picture taken by attached VK-viewer using VK-Analyzer attached to the abovementioned laser beam microscope”.

As the surface roughness, an arithmetic average roughness Ra was determined using an analyzing function contained in above mentioned VK-Analyzer according to the method of JIS B 0601 (1994) with a cutoff value of 0.08 mm. The full width of the picture at the center of the image was used for the evaluation. The evaluation criteria were as follows. Of these, criteria A and B were considered to be acceptable in the present invention.

A: The value of surface roughness Ra is 0.4 μm or more but 0.8 μm or less.

B: The value of surface roughness Ra is larger than 0.8 μm but 1.0 μm or less.

C: The value of surface roughness Ra is large than 1.0

### <Measurement of Glossiness>

The gloss of the clear toner layers provided on the images formed by each image forming device were evaluated at the beginning of printing (initial), after 100,000 sheets printing and after 210,000 sheets printing using a gloss meter GXM-203 (produced by Murakami Color Research Laboratory Co., Ltd.) shown in FIG. 5. The measurement angle, namely, angle θ shown in FIG. 5, was set to 20 degrees, and the measurement was carried out according to the method of above mentioned JIS Z8741 1983 method 2. The glossiness of 60 or more was considered to be acceptable and the glossiness of 80 or more was evaluated to be excellent in the present invention.

The results were shown in Table 2.

TABLE 2

| | | | | | Glossiness | | | | | | | | |
|---|---|---|---|---|---|---|---|---|---|---|---|---|---|
| | | Deterioration | | | Electrophotographic | | | | | | | | |
| | Clear | of belt | | | image | | | Inkjet image | | | Printed image | | |
| | toner | | 100,000 | 210,000 | | 100,000 | 210,000 | | 100,000 | 210,000 | | 100,000 | 210,000 |
| | no. | *1 | sheets | sheets | *1 | sheets | sheets | *1 | sheets | sheets | *1 | sheets | sheets |
| **1 | 1 | A | A | A | 93 | 90 | 88 | 94 | 92 | 90 | 93 | 91 | 89 |
| **2 | 2 | A | A | A | 88 | 83 | 84 | 89 | 85 | 84 | 87 | 86 | 83 |
| **3 | 3 | A | A | A | 86 | 82 | 82 | 87 | 83 | 81 | 85 | 84 | 82 |
| **4 | 4 | A | A | B | 84 | 80 | 75 | 86 | 83 | 76 | 85 | 80 | 76 |
| **5 | 5 | A | A | B | 83 | 81 | 74 | 84 | 80 | 75 | 83 | 79 | 74 |
| **6 | 6 | A | A | A | 85 | 83 | 80 | 85 | 83 | 81 | 87 | 84 | 81 |
| **7 | 7 | A | A | A | 84 | 82 | 80 | 85 | 81 | 80 | 84 | 83 | 80 |
| Comp. 1 | 8 | A | C | C | 83 | 74 | 54 | 84 | 73 | 54 | 82 | 74 | 53 |
| Comp. 2 | 9 | A | B | B | 56 | 49 | 42 | 54 | 47 | 40 | 52 | 45 | 39 |
| Comp. 3 | 10 | A | B | B | 54 | 46 | 40 | 56 | 49 | 45 | 53 | 46 | 45 |
| Comp. 4 | 11 | A | C | C | 82 | 74 | 63 | 83 | 73 | 60 | 83 | 72 | 59 |
| Comp. 5 | 12 | A | C | C | 80 | 72 | 45 | 82 | 74 | 53 | 84 | 71 | 49 |

Comp.: Comparative example,
**Example,
*1: Initial

As shown in Table 2, no deterioration of the belt member was observed even after 210,000 sheets printing for each of Examples 1-7 employing Clear toners 1-7 all of which are within the scope of the present invention. Accordingly, it was confirmed that the belt member was hardly affected. Also, it was confirmed that, in Examples 1-7, a clear toner layer exhibiting a high glossiness which is in a level of specular reflection was stably formed on each of a toner image, an inkjet image and a printed image.

On the other hand, in Comparative Examples 1-5 employing Clear toners 8-12 none of which meets the constitution of the present invention, it was confirmed that the deterioration of the belt member proceeded as the number of formed clear toner layer was increased, whereby a clear toner layer having a prescribed glossiness was hardly formed. As for comparative examples 1 and 5, when the surface temperature of the heating roll was set to 175°, a high glossiness was obtained while when the surface temperature of the heating roll was set to 155°, no high glossiness was obtained, however, the deterioration of the belt member drastically proceeded.

As for Comparative examples 2 and 3, no high gloss was obtained within the processing condition mentioned above. Namely, in Comparative example 2, unevenness occurred in the clear toner layer forming step and also exfoliation of the print could not be smoothly carried out due to the too large adhesion forth to the belt member, whereby a conveyance error frequently occurred. In Comparative example 3, also, a conveyance error frequently occurred the due to the too large adhesion forth to the belt member, and, when the surface temperature of the heating roll was set to higher than 155° C., evaluation could not be conducted due to the further high adhesion forth.

As shown in Table 2, Comparative examples 2 and 3 showed a certain level of suppression effect of deterioration of the belt member even after the 210,000 sheets print, however, no high glossiness was obtained. Further, in Comparative examples 2 and 3, in addition to the conveyance error as abovementioned, when the transfer material was exfoliated from the belt member, the smoothly formed clear toner layer was strongly pulled to deteriorate the surface of the image due to the high adhesion forth to the belt member, and therefore no high glossiness was obtained.

Furthermore, in Comparative example 4″, since it was necessary to lower the temperature of the transfer material when exfoliated, the thermal load applied to the belt member increased. Therefore, evaluation was carried out while assuming that it was difficult to increase the surface temperature of the heating roll higher than 155° C.

What is claimed is:

1. A method of image forming comprising the steps of:
providing a clear toner all over a transfer material on which an image is formed;
heating and pressing the transfer material having thereon the image while the transfer material is in contact with a belt;
cooling the transfer material; and
peeling the transfer material from the belt, whereby a clear toner layer formed on the transfer material is obtained, wherein
a storage modulus G′ at 60° C. of the clear toner is 1×10⁶ N/m² or more, but 1×10⁸ N/m² or less; and
a viscosity η at 130° C. of the clear toner is 1×10¹ Pa·s or more, but 1×10² Pa·s or less.

2. The method of claim 1, wherein the clear toner comprises a resin prepared by using a polycarboxylic acid monomer.

3. The method of claim 2, wherein the polycarboxylic acid monomer comprises itaconic acid, maleic acid or a mixture thereof.

4. The method of claim 3, wherein the polycarboxylic acid monomer is itaconic acid.

5. The method of claim 3, wherein the polycarboxylic acid monomer is maleic acid.

6. The method of claim 2, wherein a used amount of the polycarboxylic acid monomer is 3 to 15% by mass based on a total mass of the clear toner.

7. The method of claim 2, wherein a used amount of the polycarboxylic acid monomer is 5 to 10% by mass based on a total mass of the clear toner.

8. The method of claim 1, wherein the clear toner has a core-shell structure.
